(19) United States
(12) Patent Application Publication
(10) Pub. No.: US 2018/0200838 A1
(43) Pub. Date: Jul. 19, 2018

(54) LASER PROCESSING METHOD

(71) Applicant: FANUC CORPORATION, Yamanashi (JP)

(72) Inventor: Takashi IZUMI, Yamanashi (JP)

(73) Assignee: FANUC CORPORATION, Yamanashi (JP)

(21) Appl. No.: 15/874,440

(22) Filed: Jan. 18, 2018

(30) Foreign Application Priority Data
Jan. 19, 2017 (JP) 2017-007927

(51) Int. Cl. B23K 26/382; B23K 26/40; B23K 26/04; B23K 26/70

(52) U.S. Cl. CPC B23K 26/382; B23K 26/703; B23K 26/048; B23K 26/40

(57) ABSTRACT

To provide a laser processing method capable of performing laser processing quickly and inexpensively without causing cracks, damages, and deformations of a ceramic workpiece. When a workpiece is irradiated with the laser beam, the product of an irradiation time, a power, by an absorption rate of the laser beam is set to be equal to or more than an energy required for melting a volume of a melting target portion of the workpiece. A melted material of the workpiece generated according to the irradiation of a laser beam is removed from a laser received area of the workpiece.

This application is based on and claims the benefit of priority from Japanese Patent Application No. 2017-007927, filed on 19 Jan. 2017, the content of which is incorporated herein by reference.

### BACKGROUND OF THE INVENTION

### Field of the Invention

The present invention relates to a laser processing method for irradiating a workpiece (ceramic workpiece) formed of a ceramic such as an alumina (aluminum oxide) with a laser beam and processing the workpiece.

### Related Art

Conventionally, when a ceramic workpiece is irradiated with a laser beam and processed, drilling of the workpiece is performed by laser irradiation of a pulse width of some μ seconds or less (refer to Patent Documents 1 and 2 as examples).

Patent Document 1: Japanese Unexamined Patent Application, Publication No. H06-155061

Patent Document 2: Japanese Unexamined Patent Application, Publication No. 2015-047638

### SUMMARY OF THE INVENTION

However, this is inconvenient as follows.

First, the ceramic has lower heat conductivity than that of metals such as an aluminum. For example, as shown in FIG. 4, an alumina has a heat conductivity of 23 W/m*K. Thus, drilling takes much time when the thickness of the ceramic workpiece is 1 mm or more, and since the heat conductivity is low, a periphery of a processing point locally has high temperature. When drilling is performed successively to the ceramic workpiece, heat is accumulated. Thus, large temperature difference is locally generated in the ceramic workpiece, and thereby, cracks, damages, and deformations are easy to occur in the ceramic workpiece.

Second, the ceramic has high wavelength dependency. Generally, when microfabrication is performed, the type of laser that can decrease a light convergence diameter is selected. However, when the reflectivity is high (absorption rate is low), an oscillator having high output needs to be used. Thus, a device (laser machine) including a laser oscillator becomes larger, and the cost for the laser processing becomes higher.

The present invention has an object to provide a laser processing method capable of performing laser processing quickly and inexpensively without causing cracks, damages, and deformations of a ceramic workpiece, even when laser processing is performed to a ceramic workpiece having a thickness of 1 mm or more, or when laser processing is performed successively to a ceramic workpiece.

(1) A laser processing method according to the present invention irradiates a ceramic workpiece (for example, a workpiece 3 described later) with a laser beam (for example, a laser beam LB described later) and processes the ceramic workpiece. When the workpiece is irradiated with the laser beam, the product of an irradiation time, a power, by an absorption rate of the laser beam is set to be equal to or more than an energy required for melting a volume of a melting target portion of the workpiece. A melted material (for example, a melted material 10 described later) of the workpiece generated according to the irradiation of this laser beam is removed from a laser received area (for example, a laser received area 3a described later) of the workpiece.

(2) In the laser processing method of (1), the melting target portion of the workpiece may have a shape that is approximated to a cylinder having a circular bottom surface having a diameter of 0.01 mm to 1 mm corresponding to a spot size of the laser beam, and a height of 100 μm or more corresponding to a melting depth of the workpiece.

(3) In the laser processing method of (1) or (2), when the melted material of the workpiece is removed from the laser received area of the workpiece, a negative pressure may be generated in the laser received area of the workpiece to suck and remove the melted material.

(4) In the laser processing method of (1) to (3), when the workpiece is irradiated with the laser beam, the laser received area of the workpiece is coated with an antireflection coating beforehand, to increase the absorption rate of the laser beam.

(5) In the laser processing method of (4), the antireflection coating may have a thickness of 0.1 mm or less.

(6) In the laser processing method of any of (1) to (5), when the workpiece is irradiated with the laser beam, according to the remaining thickness of the workpiece, a focus position of the laser beam may be moved to a rear surface side of the workpiece.

(7) In the laser processing method of (6), when the focus position of the laser beam is moved, movement operation and stop operation of the focus position may be performed alternately to stop the irradiation operation of the laser beam during the movement of the focus position, and perform irradiation operation of the laser beam during the stop of this focus position.

(8) In the laser processing method of any of (1) to (7), when the workpiece is irradiated with the laser beam, an ambient temperature of the laser received area of the workpiece is measured. When the ambient temperature of the laser received area exceeds a specified value, the irradiation operation of the laser beam to the laser received area may be interrupted.

(9) In the laser processing method of any of (1) to (8), when the workpiece is irradiated with the laser beam, the ambient temperature of the laser received area of the workpiece is measured. When the ambient temperature of the laser received area exceeds a specified value, the laser received area may be cooled.

(10) In the laser processing method of any of (1) to (9), the laser beam may be a carbon dioxide gas laser, a fiber laser, a direct diode laser, or a YAG laser.

By the present invention, laser processing can be performed quickly and inexpensively without causing cracks, damages, and deformations of a ceramic workpiece, even when laser processing is performed to a ceramic workpiece having a thickness of 1 mm or more, or when laser processing is performed successively to a ceramic workpiece.

### BRIEF DESCRIPTION OF THE DRAWINGS

FIG. 1 is a schematic configuration diagram showing a laser machine according to a first embodiment of the present invention.

FIG. 2 is a vertical cross section view showing a nozzle of the laser machine according to the first embodiment of the present invention.

FIG. 3 is a semi log graph showing a relationship between a wavelength and a reflectivity of a laser beam.

FIG. 4 is a table showing the physical property of alumina.

### DETAILED DESCRIPTION OF THE INVENTION

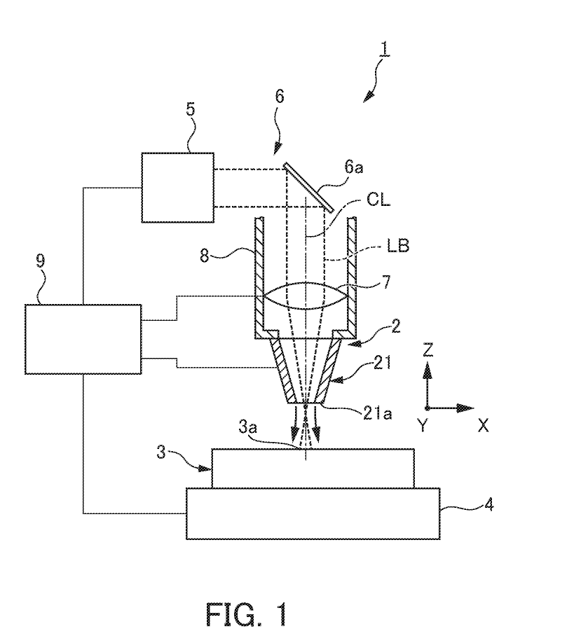

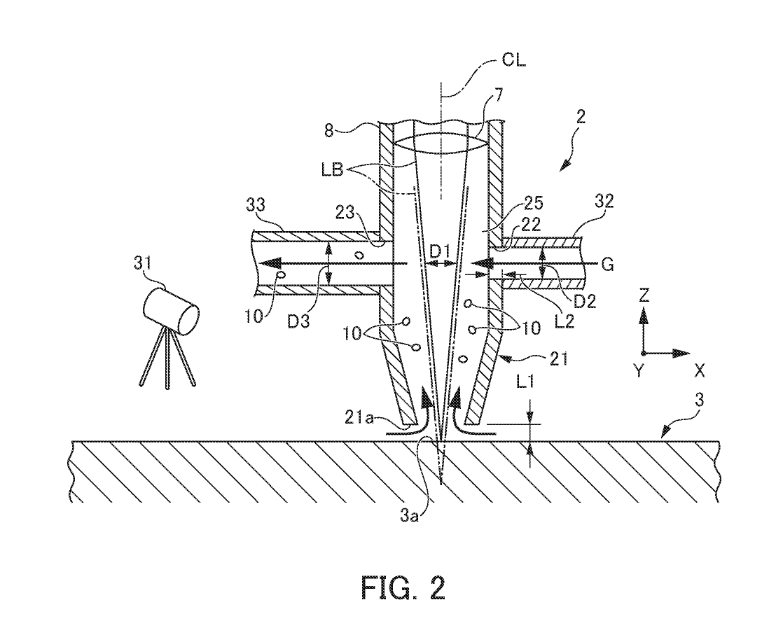

Following describes an example of embodiments of the present invention. FIG. 1 is a schematic configuration diagram showing a laser machine according to a first embodiment of the present invention. FIG. 2 is a vertical cross section view showing a nozzle of the laser machine according to the first embodiment of the present invention.

As shown in FIG. 1, a laser machine 1 according to the first embodiment includes: a movable table 4 that horizontally supports a flat plate-shaped workpiece 3 of aluminum; a laser oscillator 5 that emits a laser beam LB having a circular cross section; a light guide path 6 that guides the laser beam LB emitted from the laser oscillator 5 to the workpiece 3; a processing head 8 that focuses the laser beam LB by a focusing lens 7 and irradiates the workpiece 3 with the laser beam LB; a nozzle 2 mounted to a tip end of the processing head 8; and a controller 9 that controls operation of the movable table 4, the laser oscillator 5, and the processing head 8.

The movable table 4 is movable to an X axis direction and a Y axis direction. The processing head 8 is movable to a Z axis direction. The focusing lens 7 is movable to a Z axis direction inside of the processing head 8. The light guide path 6 includes a reflector 6a that reflects the laser beam LB emitted from the laser oscillator 5, to guide the laser beam LB to the focusing lens 7. The type of the laser beam LB is not limited. For example, the laser beam LB may be used a carbon dioxide gas laser, a fiber laser, a direct diode laser, and a YAG laser.

As shown in FIG. 2, the nozzle 2 includes: a substantially nozzle tip body 21 that irradiates the workpiece 3 with the laser beam LB; a charge port 22 formed in the nozzle tip body 21; and an exhaust port 23 formed in the nozzle tip body 21 so as to oppose to the charge port 22. The charge port 22 is connected with a cylindrical charge tube 32. The exhaust port 23 is connected with a cylindrical exhaust tube 33. The nozzle 2 is configured to supply gas G to the inside of the nozzle tip body 21 along a linear gas flow path 25 extending from the charge port 22 to the exhaust port 23 in a form of crossing across the optical axis CL of the laser beam LB in the nozzle tip body 21, to generate a negative pressure in the vicinity of an opening part 21a of a tip end of the nozzle tip body 21.

As shown in FIG. 2, a diameter D2 of the charge port 22 is a diameter D1 in a portion across which the gas G of the laser beam LB in the nozzle tip body 21 crosses, or more (D2≥D1). A diameter D3 of the exhaust port 23 is larger than the diameter D2 of the charge port 22 (D3>D2). For example, it is defined that D3=5 mm, and D2=1 mm. The charge port 22 has a linear portion of a predetermined length L2 (for example, 1 mm) for improving linearity of the gas G.

The nozzle 2 is configured to, when the gas G is supplied along the gas flow path 25, for example, adjust the pressure and the flow rate of the gas G, appropriately, to cause the melted material 10 generated according to the drilling of the workpiece 3 to apply a suction force of the weight of the melted material 10 or more. The melted material 10 is sucked from the opening part 21a of the nozzle tip body 21, and discharged to the outside of the nozzle tip body 21 from the exhaust port 23.

In the vicinity of the nozzle 2, a thermography 31 is installed so as to measure an ambient temperature of a laser received area 3a of the workpiece 3.

The laser machine 1 has a configuration as described above. Drilling of the workpiece 3 of alumina by using the laser machine 1 is performed by following procedures.

First, as shown in FIG. 1, in a state where the workpiece 3 is placed on the movable table 4, according to the command from the controller 9, the movable table 4 is moved as appropriate to the X axis direction and the Y axis direction, and the workpiece 3 is positioned in a predetermined position of the X axis direction and the Y axis direction.

Next, according to the command of the controller 9, the processing head 8 is moved as appropriate to the Z axis direction, and the nozzle 2 is positioned in a predetermined position of the Z axis direction. Then, as shown in FIG. 2, in the nozzle 2, the opening part 21a of the nozzle tip body 21 is apart upward from the surface of the workpiece 3 for a predetermined distance L1 (for example, L1=0.5 mm to 5 mm).

Further, according to the command from the controller 9, the focusing lens 7 is moved as appropriate to the Z axis direction in the processing head 8. Then, in a state where the distance L1 between the opening part 21a of the nozzle tip body 21 and the surface of the workpiece 3 is maintained, the focus position of the laser beam LB is positioned in the predetermined position in the Z axis direction.

Next, according to the command from the controller 9, and the gas G is supplied in a predetermined pressure (for example, 0.5 MPa), to the inside of the nozzle tip body 21 along the gas flow path 25 extending from the charge port 22 to the exhaust port 23. Then, the gas in the inside of the nozzle tip body 21 is exhausted by being caught by the flow of the gas G. Thus, a negative pressure is generated in the vicinity of the opening part 21a of the nozzle tip body 21.

At this time, the exhaust port 23 opposes to the charge port 22, the diameter D3 of the exhaust port 23 is larger than the diameter D2 of the charge port 22, and the linear portion of the predetermined length L2 that improves linearity of the gas G is provided in the charge port 22. Thus, the gas G supplied from the charge port 22 to the inside of the nozzle tip body 21 is entirely exhausted from the exhaust port 23. As a result, unnecessary supply of the gas G does not occur, and generation of the negative pressure can be performed efficiently.

Further, according to the command from the controller 9, the ambient temperature of the laser received area 3a of the workpiece 3 is measured by using the thermography 31.

In this state, according to the command from the controller 9, the laser beam LB is emitted from the laser oscillator 5. Then, the laser beam LB is guided along the light guide path 6 and is focused by the focusing lens 7, and the workpiece 3 is irradiated with the laser beam LB from the opening part 21a of the nozzle tip body 21 of the nozzle 2. As a result, in the workpiece 3, a laser received area 3a of the workpiece 3 is melted by the laser irradiation of the laser beam LB, and drilling starts.

At this time, the product of an irradiation time, a power, by an absorption rate of the laser beam LB is set to be equal to or more than an energy required for melting a volume of a melting target portion of the workpiece 3. The melting target portion of the workpiece 3 is considered to have a shape that is approximated to a cylinder, since the laser beam LB has a circular cross section. This cylinder has a circular bottom surface having a diameter of 0.01 mm to 1 mm corresponding to a spot size of the laser beam, and a height of 100 μm or more corresponding to a melting depth of the workpiece.

The spot size of the laser beam LB means a cross sectional area of the laser beam LB in the laser received area 3a of the workpiece 3. The melting depth of the workpiece 3 means a depth of the laser received area 3a of the workpiece 3 melted by the irradiation of the laser beam LB.

When the laser beam LB having high reflectivity to the workpiece 3 is selected and irradiation is performed with the laser beam LB, it is desirable that the laser received area 3a of the workpiece 3 is coated with an antireflection coating having a thickness of 0.1 mm or less beforehand, to increase the absorption rate of the laser beam LB with respect to the workpiece 3. This is because, since the absorption rate is low, melting requires much time, and thermal diffusion occurs. It is also considered that a tape (not shown) containing an iron powder is stuck to the surface of the workpiece 3, in order to increase the absorption rate of the laser beam LB. However, with this, the melted material 10 of the workpiece may be adhered to this tape and may not be sucked. On the other hand, coating with antireflection coating is preferable since such problem does not occur.

When the workpiece 3 is thick, drilling of the workpiece 3 is not finished by one-time laser irradiation. Thus, the focusing lens 7 is moved to the Z axis direction according to the remaining thickness of the workpiece 3, and thereby, as shown in FIG. 2 by a two-dot chain line, the focus position of the laser beam LB is moved to a rear surface side (lower part of FIG. 2) of the workpiece 3, for the predetermined number of times (for example, three times).

At this time, movement operation and stop operation of the focus position may be performed alternately to stop the irradiation operation of the laser beam LB during the movement of the focus position, and perform irradiation operation of the laser beam LB during the stop of this focus position. By this operation, discharge time of the melted material 10 of the workpiece 3 can be had during the stop of the laser irradiation. Thus, it can be prevented that the melted material 10 is irradiated with the laser beam LB, the laser beam LB is reflected to the workpiece 3, and the ambient temperature increases.

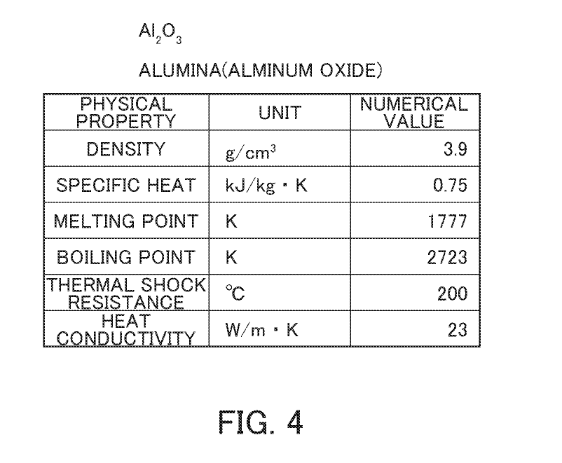

As shown in FIG. 4, the thermal shock resistance of the alumina is 200° C. Thus, when the temperature difference of the laser received area 3a of the workpiece 3 exceeds this temperature during the drilling of the workpiece 3, the material breaks. When the temperature of the laser received area 3a of the workpiece 3 cannot be measured in high precision directly by the thermography, or the like, when the ambient temperature of the laser received area 3a exceeds a specified value (for example, 60° C.), the irradiation operation of the laser beam LB with respect to the laser received area 3a is interrupted. Then, the laser received area 3a is waited to be cooled, or laser processing is performed first to a portion of which temperature does not exceed the specified value. At this time, the laser received area 3a may be forcibly cooled by being applied with air or cooling water.

At this time, according to the drilling of the workpiece 3, the laser received area 3a of the workpiece 3 is heated and melted by laser. When an energy amount supplied to the laser received area 3a is large, the temperature of the laser received area 3a instantaneously exceeds the boiling point, the melted material 10 is generated in the laser received area 3a, and the melted material 10 splashes to the coaxial direction of the laser beam LB. However, the gas G flows in the nozzle 2 so as to cross across the laser beam LB. Thus, the melted material 10 is prevented from reaching the focusing lens 7, and the focusing lens 7 can be protected. In addition, in the nozzle 2, the pressure in the vicinity of the opening part 21a of the nozzle tip body 21 is negative pressure due to the flow of the gas G crossing across the optical axis CL of the laser beam LB. Thus, a negative pressure is generated also in this laser received area 3a. In addition, the gas G is supplied so that a suction force of the weight of the melted material 10 or more acts. As a result, the melted material 10 is exhausted from the exhaust port 23 to the outside of the nozzle tip body 21 while sucking to the inside of the nozzle tip body 21 and cooling. Accordingly, the melted material 10 is not accumulated in the inside of the nozzle tip body 21 to disturb the irradiation of the laser beam LB. Thus, the drilling of the workpiece 3 can be performed efficiently.

In this way, when the workpiece 3 is irradiated with the laser beam LB, the product of an irradiation time, a power, by an absorption rate of the laser beam LB is set to be equal to or more than an energy required for melting a volume of a melting target portion of the workpiece 3. In addition, since the melted material 10 generated according to the irradiation of the laser beam LB is quickly removed, thermal diffusion to the other portion of the workpiece 3 than the laser received area 3a, and cracks, damages, and deformations of the workpiece 3 due to overheating can be prevented. As a result, laser processing can be performed without causing cracks, or the like of the workpiece 3, even when laser processing is performed to the workpiece 3 having a thickness of 1 mm or more, or when laser processing is performed successively to the alumina workpiece 3.

In addition, by coating of the laser received area 3a of the workpiece 3 with an antireflection coating, even the laser beam LB having high reflectivity can be increased in the absorption rate. Thus, the laser oscillator 5 having small output can be used, and laser processing can be performed quickly and inexpensively.

When the drilling of the workpiece 3 is finished in this way, since the laser received area 3a of the workpiece 3 passes through from the surface to the rear surface of the workpiece 3, the melted material 10 of the workpiece 3 can be discharged downward from the rear surface of the workpiece 3. Accordingly, after that, there is no need for sucking the melted material 10 of the workpiece 3. Thus, cutting of the workpiece 3 can he performed while the opening and closing valve 12 is closed to block the exhaust of the gas G, and assist gas is supplied from the nozzle 2.

The present invention is not limited to the first embodiment described above. Variation and modification in the scope in which the object of the present invention can be achieved are included in the present invention.

For example, in the first embodiment and the second embodiment, a case where only the focusing lens 7 is included as the optical system in the processing head 8. However, even when a window (not shown) that protects the focusing lens 7 is attached in the lower part of the focusing lens 7, the present invention can be similarly applied.

In the first embodiment described above, a case where the laser processing is performed in a state where the opening part 21a of the nozzle tip body 21 is apart from the predetermined distance L1 from the surface of the workpiece 3, is described. However, for example, an elastic member (not shown) formed of a cylindrical silicon rubber may be attached to a lower side of the opening part 21a of the nozzle tip body 21 so as to contact with the workpiece 3, to increase the degree of enclosure of the nozzle tip body 21 and the suction force of the melted material 10.

In the first embodiment described above, a case where the thermography 31 is used for measuring the temperature of the laser received area 3a of the workpiece 3 is described. However, various types of temperatures sensors (not shown) may be used, instead of the thermography 31.

In the first embodiment described above, a case where the laser processing is performed to the workpiece 3 of alumina is described. However, even when the laser processing is performed to the workpiece formed of a ceramic other than alumina, the present invention can be similarly applied.

### EXAMPLES

Following describes examples of the present invention. The present invention is not limited to the examples.

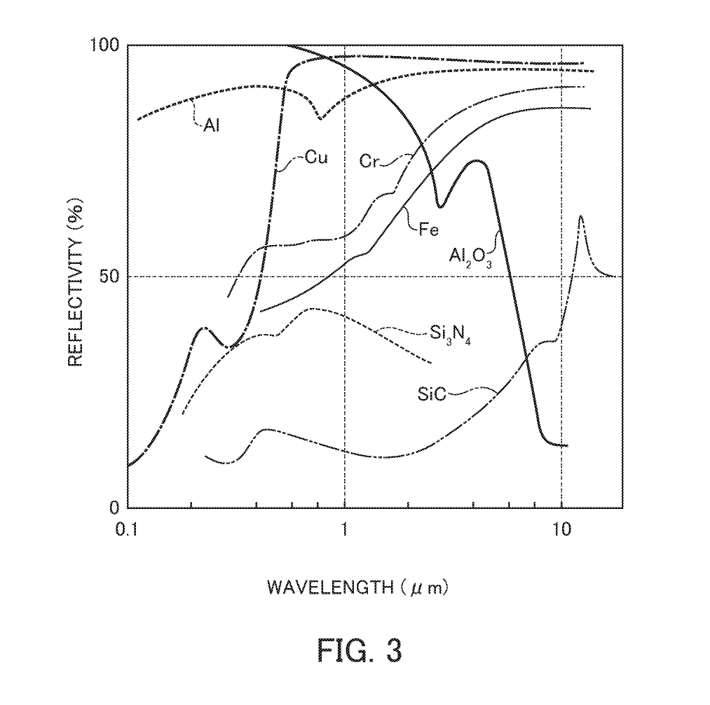

FIG. 3 is a semi log graph showing a relationship between a wavelength and a reflectivity of a laser beam. In the graph of FIG. 3, a horizontal axis (log) represents a wavelength (unit: μm) of the laser beam, and the vertical axis represents a reflectivity (unit: %) of the laser beam. FIG. 4 is a table showing the physical property of alumina.

### Example 1

Laser processing is performed to a workpiece of alumina having a thickness of 2 mm by the laser processing method according to the first embodiment described above, by using a carbon dioxide gas laser. As is clear from FIG. 3, the carbon dioxide gas laser (wavelength: about 10 μm) has the reflectivity to the alumina of about 20%, that is, the absorption rate of about 80%. As shown in FIG. 4, the alumina has the density of 3.9 g/cm³, the specific heat of 0.75 kJ/kg*K, the melting point of 1777K, and the boiling point of 2723K.

In consideration with these, the energy required for melting the workpiece, and the energy required for boiling the workpiece are calculated. That is, when it is assumed that a melting target portion of the workpiece is a cylindrical shape, a bottom surface (that is, a shape corresponding to a spot size of the laser beam) of the workpiece is a circle shape having the diameter of 0.5 mm, and the height (that is, a shape corresponding to a melting depth of the workpiece) is 0.1 mm, a volume of this cylinder is 0.25 mm×0.25 mm×3.14×0.1 mm=0.0196 mm³ when pi is assumed as 3.14. Accordingly, the weight of this cylinder is obtained by multiplying the density to this volume, as 0.0196 mm³×3.9 g/cm 3=0.0765×10⁻³ g. As a result, when a room temperature is assumed to be 293 K, an energy required for melting the workpiece is calculated as 0.0765×10⁻³ g×(1777 K-293 K)×0.75 kJ/kg*K=0.085 J. The energy required for boiling the workpiece is calculated as 0.0765×10⁻³ g×(2723K-293K)×0.75 kJ/kg*K=0.139 J.

On the other hand, when it is assumed that the laser oscillator has the power of 100 W, the duty of 20%, the frequency of 1000 Hz, and irradiation time of 0.005 seconds, and the absorption rate to the alumina is 80%, the energy imparted by the laser oscillator is 1000 W×20%×0.005 seconds×0.8=0.8 J. Thus, the energy (0.8 J) imparted by the laser oscillator is larger than the energy (0.139 J) required for boiling the workpiece.

As a result, this workpiece was melted in a form of instantaneously exceeding the boiling point. By this instantaneous removal of the melted material generated according to the laser irradiation, heat conduction from the melted material to a base material could be reduced. Thus, overheating of the base material could be reduced. In this way, when the temperature of the workpiece exceeds the boiling point, the melted material sometimes splashes to the irradiation direction of the laser. Even in such case, the melted material is flown away by the flow of gas G crossing across the optical axis of the laser beam, and does not contaminate the focusing lens.

It is considered that a hole having a depth of about 0.3 mm to 0.4 mm is formed by one-time laser irradiation. Thus, the laser irradiation was repeated 5 or 6 times while the focus position of the laser beam is moved to the rear surface side of the workpiece by 0.3 mm for each time. As a result, a hole having the diameter of 0.5 mm is formed by passing through the workpiece of alumina having the thickness of 2 mm.

### Example 2

The laser processing is performed to a workpiece of alumina having the thickness of 2 mm, as similar to the embodiment 1 described above, except that the type of the laser is replaced from the carbon dioxide gas laser to the fiber laser. As is clear from FIG. 3, the fiber laser (wavelength: 1 μm) has the absorption rate to the alumina of about 8%, that is, 1/10 absorption rate of the carbon gas laser (see example 1). Thus, when the laser processing is performed by the same laser output, it takes. When the processing time takes longer, the risk that the base material is heated by heat conduction and cracks becomes higher. When the laser processing is performed by the same time, a laser having 10 times lager output needs to be prepared.

Then, in order to shorten the processing time, before the laser irradiation, an antireflection agent (“Black guard spray” produced by Fine Chemical Japan Co., LTD.) is sprayed to the surface of the workpiece to coat the antireflection coating, and thereby, the absorption rate of the laser beam is increased. Thereby, even when the laser oscillator having high output is not used, a hole could be formed to the workpiece of alumina having the thickness of 2 mm, while cracks in the base material is prevented.

### EXPLANATION OF REFERENCE NUMERALS

3 Workpiece
3a Laser received area
10 Melted material
LB Laser beam

What is claimed is:

1. A laser processing method that irradiates a ceramic workpiece with a laser beam and processes the ceramic workpiece,
when the workpiece is irradiated with the laser beam, the product of an irradiation time, a power, by an absorption rate of the laser beam being set to be equal to or more than an energy required for melting a volume of a melting target portion of the workpiece, a melted material of the workpiece generated according to the irradiation of this laser beam being removed from a laser received area of the workpiece.

2. The laser processing method according to claim 1, wherein the melting target portion of the workpiece has a shape that is approximated to a cylinder having a circular bottom surface having a diameter of 0.01 mm to 1 mm corresponding to a spot size of the laser beam, and a height of 100 μm or more corresponding to a melting depth of the workpiece.

3. The laser processing method according to claim 1, wherein, when the melted material of the workpiece is removed from the laser received area of the workpiece, a negative pressure may be generated in the laser received area of the workpiece to suck and remove the melted material.

4. The laser processing method according to claim 1, wherein, when the workpiece is irradiated with the laser beam, the laser received area of the workpiece is coated with an antireflection coating beforehand, to increase the absorption rate of the laser beam to the workpiece.

5. The laser processing method according to claim 4, wherein the antireflection coating has a thickness of 0.1 mm or less.

6. The laser processing method according to claim 1, wherein, when the workpiece is irradiated with the laser beam, according to the remaining thickness of the workpiece, a focus position of the laser beam is moved to a rear surface side of the workpiece,

7. The laser processing method according to claim 6, wherein, when the focus position of the laser beam is moved, movement operation and stop operation of the focus position may be performed alternately to stop the irradiation operation of the laser beam during the movement of the focus position, and perform irradiation operation of the laser beam during the stop of this focus position.

8. The laser processing method according to claim 1, wherein, when the workpiece is irradiated with the laser beam, an ambient temperature of the laser received area of the workpiece is measured, and when the ambient temperature of the laser received area exceeds a specified value, the irradiation operation of the laser beam to the laser received area is interrupted.

9. The laser processing method according to claim 1, wherein, when the workpiece is irradiated with the laser beam, the ambient temperature of the laser received area of the workpiece is measured, and when the ambient temperature of the laser received area exceeds a specified value, the laser received area is cooled.

10. The laser processing method according to claim 1, wherein the laser beam is a carbon dioxide gas laser, a fiber laser, a direct diode laser, or a YAG laser.
